(19) United States
(12) Patent Application Publication
(10) Pub. No.: US 2006/0078016 A1
(43) Pub. Date: Apr. 13, 2006

(54) Matched filter used as an integral part of an SBS system for within cavity pulse reconstruction

(75) Inventor: Jerome B. Franck, Fairfax, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: DEPT OF THE ARMY

(21) Appl. No.: 10/962,812

(22) Filed: Oct. 7, 2004

(51) Int. Cl. H01S 3/13

(52) U.S. Cl. 372/30

(57) ABSTRACT

The invention is a high power laser source, which includes a diode pumped laser having an oscillator that produces an output laser pulse. The output laser pulse is passed through a matched filter. The filter filters and focuses the output laser pulse into an SBS cell such that the SBS cell produces a return pulse that is both phase conjugated and sliced. Then, the return pulse returns back through the matched filter and enters the oscillator such that the oscillator acts as a two pass amplifier. The high power laser also includes a beam expander, which reduces the optical damage sustained previously by reducing the high power density for sub-nanosecond systems operating at high-energy outputs as demonstrated previously. The passive extraction system extracts an output high power pulse after three passes through the system using polarization rotation. The passive extraction system may also extract the output pulse by using a nonlinear element at the actual extraction point using a material that becomes highly reflective at the expected intensity.

### CROSS-REFERENCE TO RELATED APPLICATIONS

The present application is related to co-pending application, U.S. Ser. No. ______, filed ______, by Jerome B. Franck and entitled, “Zonal Lenslet Array.”

### GOVERNMENT INTEREST

The invention described herein may be manufactured, used, sold, imported, and/or licensed by or for the Government of the United States of America.

### FIELD OF INTEREST

This invention relates to a Nd:YAG laser pulse shortening techniques using both bulk plasma switching and stimulated Brillouin scattering to reduce pulse lengths.

### BACKGROUND OF THE INVENTION

Laser sources suffer from the fundamental problem that while the mechanisms that produce amplification by stimulated emission may be modified by a variety of means to produce laser pulses of different pulse lengths, there is an upper and lower limit that may be achieved. The upper limit pulse length is for, several laser sources, a continuous wave operation. The lower limit is often determined by the stability of the lasing state and several other factors, such as the pumping scheme, Q-switching, etc. However, as is most often the case, if a specific pulse length is desired, a specific configuration of the laser system must developed to meet that need. Normally, only the specified pulse length can be obtained.

Nonlinear pulse shortening (NLPS) was discovered in the early 1970's and has been discussed by various workers in the art. This technique utilizes the property of stimulated Brillouin scattering (SBS) and/or stimulated Raman scattering (SRS) to shorten pulses. Pulse lengths in the 100-psec region at 2 mJ per pulse have been created utilizing SBS and 100-psec utilizing SRS, which produces a rather larger wavelength shift. These processes have been shown to be successful in a variety of laser systems operating at a variety of wavelengths. As will be made apparent later, the present invention betters current techniques using a Nd:YAG laser that operates at wavelengths in the vicinity of 1.06 μm.

Classical SBS pulse compression is accomplished in two ways. First, to build up the acoustic grating (AG) in nonlinear medium, required to perform phase conjugation (PC), a threshold intensity level must be reached. Therefore, there is a finite build up time. This tends to steepen the rising edge of the reflected PC pulse. Second, the action of the grating envelope shortens the pulse under certain conditions. This is shown through the progression of the pulse in FIG. 1. The beam, shown schematically in FIG. 2, is focused into the SBS cell. The vertical dotted line indicates the position where the AG is initiated. Initially, the AG is formed at that point and runs downstream from that point at the velocity of sound of the medium. The PC pulse is reflected from that point and is Doppler shifted off the moving AG and travels in the opposite direction as the AG at the speed of light in the medium. Concurrently, the AG begins to form upstream in the direction of the reflected pulse. This is the beginning of the AG, hence the PC mirror, and it forms upstream at close to the speed of light. This leading edge of the AG envelope may be thought of as moving mirror traveling in the direction of the reflected pulse and in the opposite direction of the incoming pulse. This causes the energy to be redistributed into a compressed pulse as shown. The optimum pulse compression is achieved when the period times the velocity of light in the medium is equal to twice the effective interaction length, which is often quite long. The long interaction length is often accomplished by either a very long cell, a tapered wave-guide, as shown schematically at the bottom of FIG. 2, or by focusing through a long focal length lens. Furthermore, a long interaction length can only be effective if the coherence length is of approximately the same size.

The SBS limit of compression is reached when the reflected Stokes pulse is reduced to a duration τₘᵢₙ comparable with the inverse of the acoustic frequency ν_{ac}.
τₘᵢₙ=1/ν_{ac}=λ_{L}/(2nvₛ)

where λ_{L} is the laser wavelength in vacuum, n, the refractive index and vₛ, the velocity of sound, respectively. The corresponding values for some typical SBS media are summarized in the following Table 1:

TABLE 1
Parameters of common SBS media

| | Acetone | CCl₄ | CS₂ | CH₄ | N₂ |
|---|---|---|---|---|---|
| vₛ [m/s] | 1190 | 1040 | 1149 | 450 | 360 |
| n | 1.358 | 1.46 | 1.6 | 1 | 1 |
| ν_{ac} [GHz] | 3.05 | 2.86 | 3.47 | 0.85 | 0.68 |
| 1/ν_{ac} [ns] | 0.33 | 0.35 | 0.29 | 1.18 | 1.47 |

From this table it can be inferred that the achievable pulse duration τₘᵢₙ for Nd:YAG pulses is, in case of gaseous media (N₂, CH₄) on the order of 1-2 ns, and, in the case of common liquids, on the order of 300 ps.

Hence, there is a need to reduce the high power density for sub-nanosecond systems operating at high-energy outputs as demonstrated previously; to have highly reflective material at the expected intensity; and to “clean up” the beam sufficiently for propagation as a laser illumination source where range resolution is determined by pulse length and range is determined by energy output. The present invention addresses these needs.

### SUMMARY OF THE INVENTION

Accordingly, one object of the present invention is to provide dramatic reduction in beam image quality that takes place in the SBS pulse slicing process.

This and other objects of the present invention are achieved by providing for a high power laser source, which includes a diode pumped laser having an oscillator that produces an output laser pulse. The output laser pulse is then passed through the matched filter. The filter filters and focuses the output laser pulse into an SBS cell such that the SBS cell produces a return pulse that is both phase conjugated and sliced. Then, the return pulse returns back through the matched filter and enters the oscillator such that the oscillator acts as a two pass amplifier.

The high power laser also includes a beam expander, which reduces the optical damage sustained previously by reducing the high power density for sub-nanosecond systems operating at high-energy outputs as demonstrated previously. The passive extraction system extracts an output high power pulse after three passes through the system using polarization rotation. The passive extraction system may also extract the output pulse by using a nonlinear element at the actual extraction point using a material that becomes highly reflective at the expected intensity. The matched filter is expected to “clean up” the beam sufficiently for propagation as a laser illumination source where range resolution is determined by pulse length and range is determined by energy output.

The technique employed in the present invention does not utilize the process described in the Background of the Invention. Rather, the SBS cell is used primarily to produce a reflected phase conjugate of a portion of the incoming pulse. The pulse is then truncated by a mechanism that will be discussed in the Detailed Description of the Present Invention. This has the disadvantage that the reflection efficiency can never be very high. Reflection efficiencies of around 30% have been seen as opposed to over 70% that has been seen for long interaction length systems. Here only 30% of the sliced portion of the beam is useful energy. As will be discussed later, the longest switching time takes place at the peak of the pulse. Combined with AG build up time this constrains the pulse length to be between less than half of the original pulse down to a few tens of percent of the original pulse length.

The primary issue addressed by the present invention is the dramatic reduction in beam image quality that takes place in the SBS pulse slicing process. Normally, SBS phase conjugation produces a fairly high quality return beam that is of course phase conjugated. However, the violence of the plasma switch causes severe distortion of the return beam.

### BRIEF DESCRIPTION OF THE DRAWINGS

These and other objects of the invention will become readily apparent in light of the Detailed Description of the Invention and the attached drawings wherein:

FIG. 1 is a schematic representation of classical SBS pulse compression.

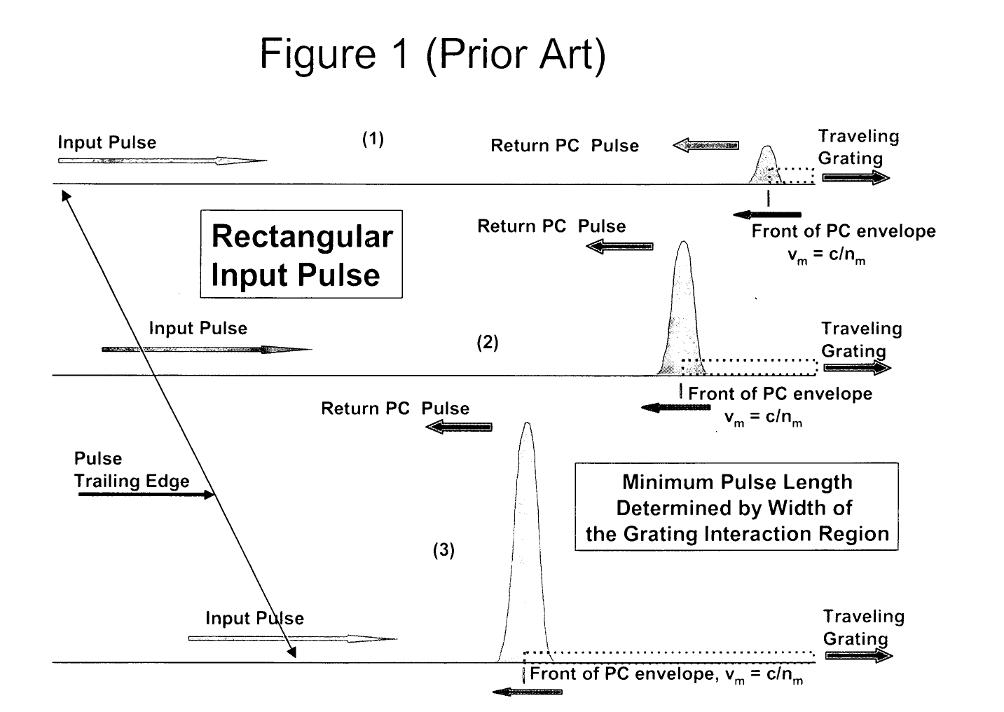

FIG. 2 is an alternate schematic representation showing the physical set up for classical pulse compression using either a long focal length lens or a tapered waveguide.

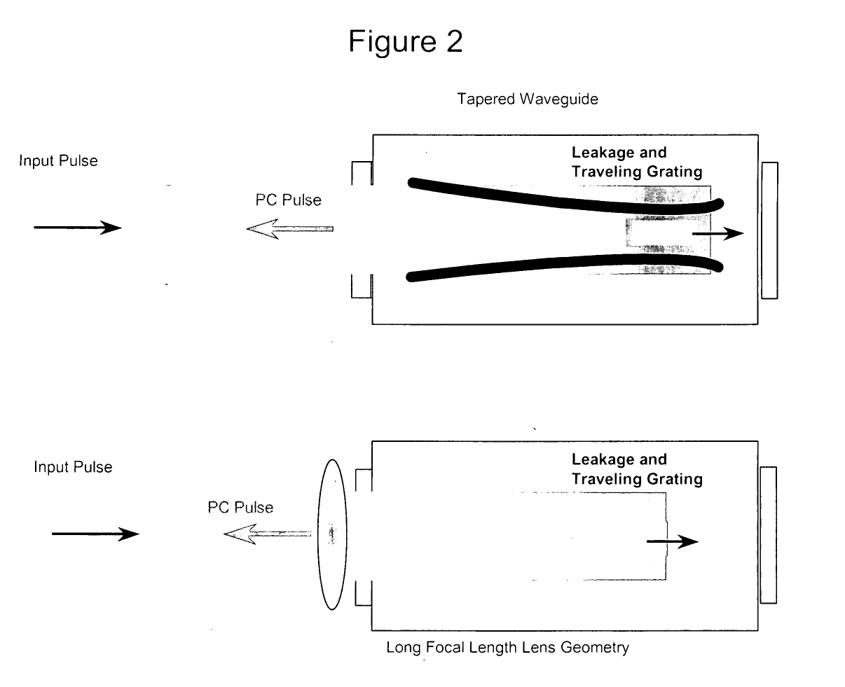

FIG. 3 is a schematic representation of the present invention.

FIG. 4 is an expanded view showing the matched filter of the present invention.

FIG. 5 shows a comparison between the first output pulse from the laser and the same laser pulse after shortening and amplification by the laser.

FIG. 6 is a graph of energy versus time showing the energy produced from the initial laser pulse.

FIG. 7 is a schematic representation of the incoming light focused into the bulk of nonlinear fluid.

FIG. 8 is a schematic representation showing a generalized view of a laser as it was initially used (upper part of the Figure). The lower portion of the figure shows the return beam entering the laser from the pulse compressor.

### DETAILED DESCRIPTION OF THE INVENTION

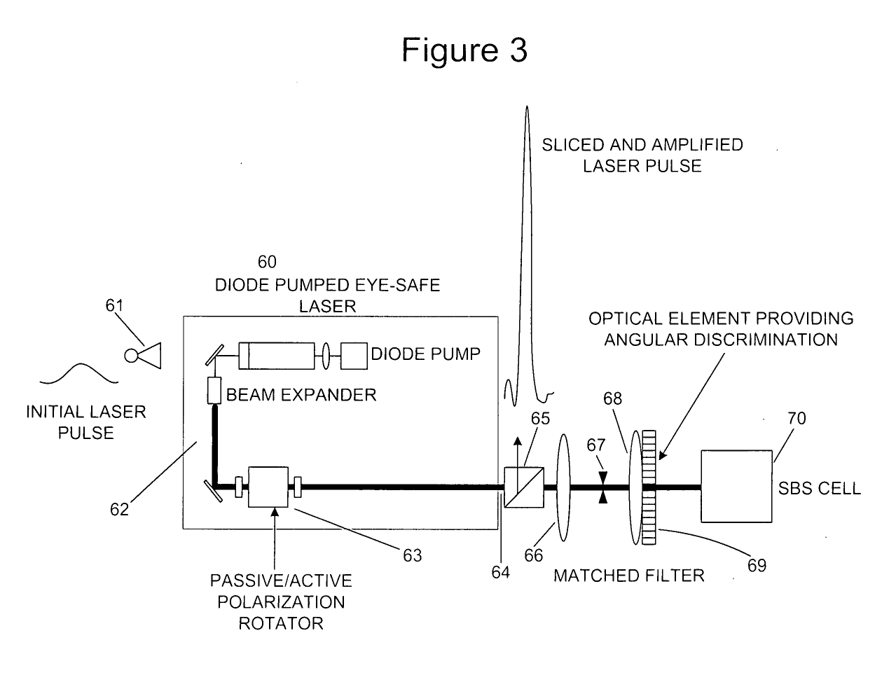

The primary issue addressed by the present invention is a dramatic reduction in beam image quality that takes place in the SBS pulse slicing process. This is shown schematically in FIG. 3, which is an improvement to the prior art already discussed above. The present invention consists of a focusing lens 66 followed by an on-axis circular aperture 67 followed by a higher power and a condensing lens 68 followed by an optical element 69, such as a two dimensional lenslet array, which provides angular discrimination. Also shown in FIG. 3 is a beam expander 62 and a passive or active method for extracting the traveling laser pulse from the system.

A diode pumped eye-safe laser 60 produces an energy at the focus that is above the air breakdown threshold. An initial laser pulse (beam) is produced via a laser source 60. The first output pulse (beam) exits the laser and is immediately expanded via beam expander 62. This is actually unnecessary for the original pulse (beam) but becomes critical for the second pulse (beam) as will be explained later. The output is then passed through a passive or active polarization rotator 63. The expanded beam is focused by lens 66 such that the energy at the focus is above the air breakdown threshold. It passes through the pinhole 67, which has a radius somewhat greater than the 1/e² Gaussian radius of the incoming laser beam. The beam then leaves the spatial filter 67 and the beam passes the second lens 68 that has a focusing power greater than the first lens 66 thus causing it to have a focus inside the SBS cell 70.

This converging beam now passes through a optical element 69 that may be thought of as a variant of the Schack-Hartman wave front sensor. This breaks the incoming wave into sections each with their own unique angle, yet all coming to a common focus and hence to a common SBS acoustic grating. This is critical so that all portions of the beam remain in phase with all other portions of the wave front in their original manner. The beams are at first phase conjugated until the plasma switching takes place and the return beam is truncated. Now, each SBS phase conjugated beam section re-enters the optical element 69. Those aberrated portions of the beam may either miss the appropriate lens or as a minimum enter the lens at an angle in variance with the original beam section. Since each lenslet has optical power, they also produce angular magnification, thus increasing their angular variance.

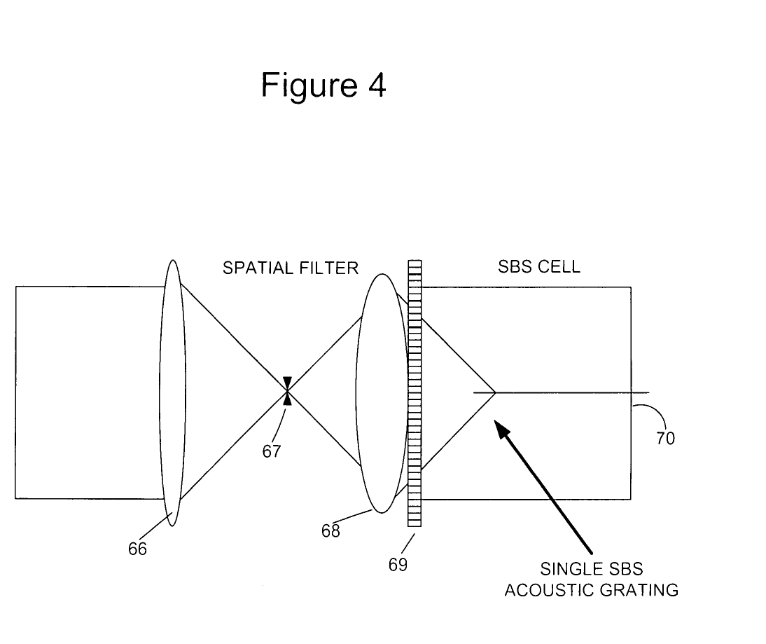

FIG. 4 shows a detail of the matched filter showing the first lens 66, pin hole 67, second lens 68, optical element 69 and the SBS cell in series.

Next, the total light from the beam passes through the second higher power lens 68 causing the beams to focus at the spatial filter. Primarily, the aberrated portion of the beam is separated from the original beam along with the higher spatial frequencies associated with the beam sampling aperture of the optical element 69. The “cleaned up” beam is now collimated by the first lens 66, passes back through the system as discussed in the prior art and is now de-magnified back to its original size and is now amplified. After its' double pass amplification the high peak power pulse emerges from the laser and is immediately expanded to prevent damage to the up-stream optical components. The beam passes through the passive or active extraction section and is ejected from the laser. On the output of the extractor is a fast photo diode to begin clocking precisely at what time the laser pulse exits the device.

As those skilled in the art know, non-linear media should be used to form most SBS based lasers. Therefore, in order to test the efficacy of the invention, two nonlinear media were explored. The first was nitrogen gas at about 80 to 100 atmospheres of pressure. The cell consisted of a 90 cm stainless steel tube with one-centimeter thick quartz windows. The second media, explored was acetone in a variety of containers. In some cases the entrance windows were made from non-optical surfaces without noticeable performance degradation. This is because the process uses phase conjugation, which tends to cancel out surface irregularity induced aberrations.

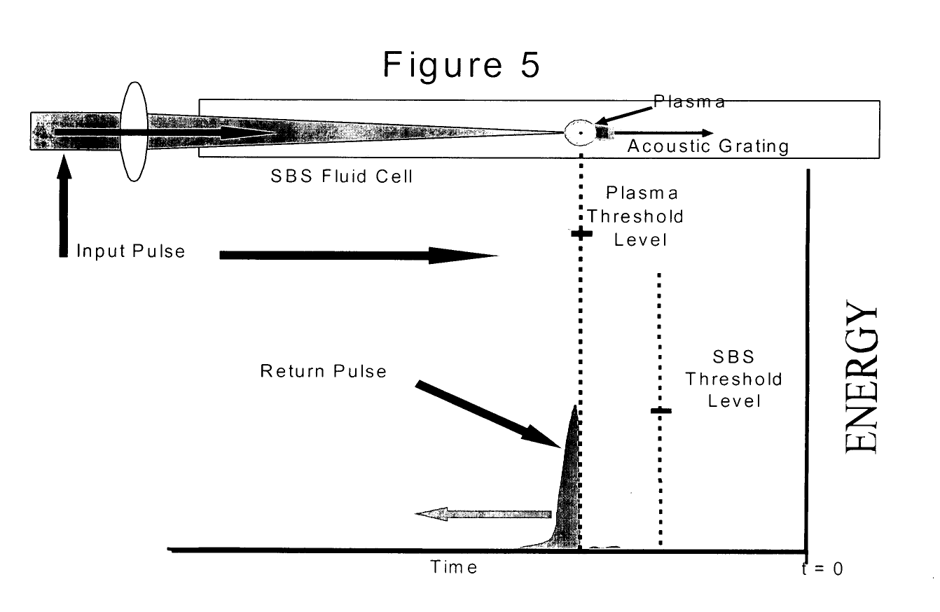

While the nature of the media used affects the sharpening of the rise time of the reflected pulse, it does not address the sharpening of the fall time of the pulse. To address this issue in the present invention, a laser-induced plasma that absorbs the incoming radiation is used, wherein the action of the plasma may be thought of as a plasma switch. Shown schematically in FIG. 5 is the action of SBS and the bulk plasma switch (BPS) on the incoming and reflected pulse. Shown in the top of FIG. 5 is the focusing of the laser into the Brillouin cell and hence represents position. Below the scale is time, and the vertical scale is power. The incoming pulse enters the focal region, and after the SBS threshold level has been reached, the AG forms, phase conjugation and the reflection process begins. This process continues until the plasma threshold takes place. The plasma essentially absorbs the incoming laser energy, SBS ceases, and the return pulse energy abruptly falls. The selection point on the curve, for the plasma threshold level, is determined by both the power of the pulse and the focal length of the lens. Judicious selection of the focal length of the lens can place the plasma threshold level at the peak of the curve. Any shorter focal length will select a plasma threshold level lower on the curve, thus producing a shorter pulse. The practical limit is determined by the SBS build up time as observed in FIG. 5.

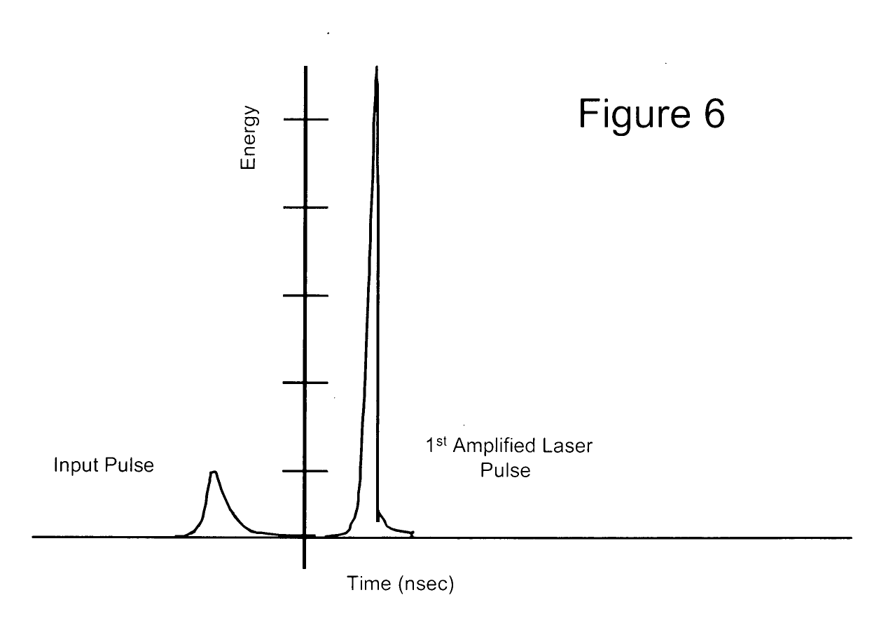

Shown in FIG. 6 is a comparison between the first output pulse from the laser and the same laser pulse after compression and amplification by the laser. FIG. 6 shows a graph of energy versus time showing the energy produced from the initial laser pulse.

### Plasma Switching

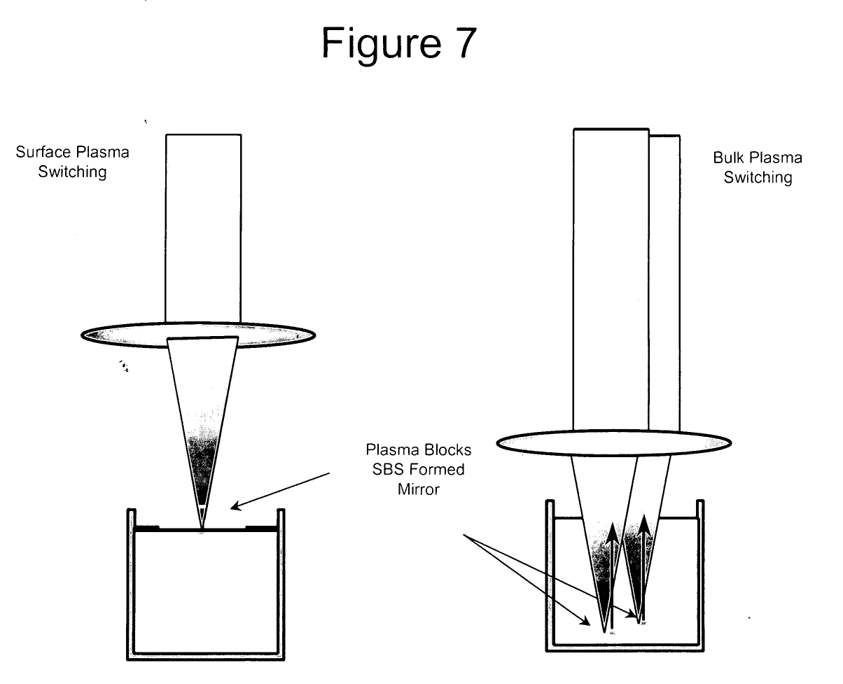

A discussion of the properties of the plasma switch is presented for the two forms; namely, the surface plasma switching (SPS) and the BPS. SPS has been discussed previously in conjunction with a SBS PC mirror to produce single shortened pulses. This is shown schematically in FIG. 7. Here, the incoming laser light (shown on the left side of FIG. 7) is focused at the surface of a nonlinear medium. At levels of radiation above the SBS threshold a PC mirror is formed, and the incoming pulse is phase conjugated and reflected. If however at some point in time during the pulse evolution the fluence levels rises to the point where a surface plasma is produced, then this plasma blocks the rest of the pulse energy from interacting with the PC mirror. Thus, the reflected pulse is truncated in time, i.e., the “fall” time is shortened. With the use of SPS, only a single shortened pulse can be created due to the plasma lifetime. This is because the development of the AG takes place in the region of the surface. In the present invention, the succeeding pulses are focused in front of the original focal region. Therefore, SPS does not prove suitable for multiple pulse generation. Additionally, SPS is not physically suitable for most practical system applications.

Also shown schematically in FIG. 7 (on the right side) is the incoming light focused into the bulk of the nonlinear fluid. When the pulse intensity is above the SBS threshold, a PC mirror is formed. Again, if the fluence level rises above the breakdown threshold, a BPS is formed. This essentially disrupts the PC process, and as before, the reflected pulse is again truncated in time. However, now if this pulse is amplified and returned, the incoming shortened pulse has a much higher fluence and hence produces a new PC mirror upstream from the previously developed PC mirror and plasma. This new PC mirror is formed, which is in turn quenched by a second plasma. As can be seen in FIG. 7, each truncated, amplified, returning pulse creates a new PC mirror and quenching plasma. Upper limits to this process may be the damage threshold of the elements of the system. This description has already addressed the issue of the number of separate paths that each beam might take when starting from the initial output to the return and succeeding pulses. The optical elements in a region about 0.5 m from the output coupler were found to have damaged off the optical axis. The following laser cavity analysis will reveal that there are two optical paths available.

### Laser Cavity Analysis

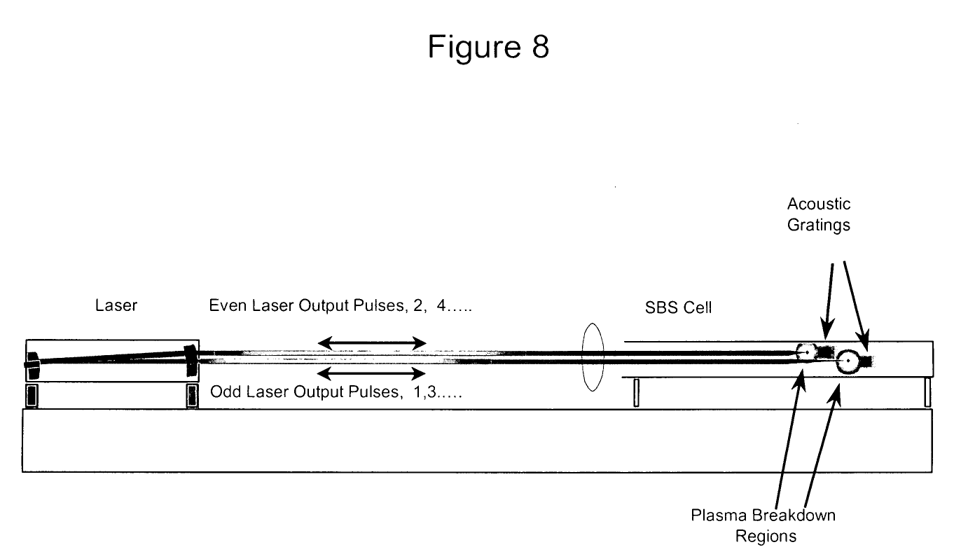

Shown schematically in FIG. 8 is a generalized view of the laser as it is initially used. As an oscillator over a mode pattern is developed over several round trips. The output from the oscillator is essentially collimated. Shown schematically is the return beam entering the laser from the pulse shortening section. Now the system acts as a double pass amplifier. Coming in from the left, the path contains, not only the gain media, but also the optical elements. The laser that was used for this experiment had an asymmetry due to the pumping scheme and this was countered by a slight vertical misalignment of the rear, 100% mirror. This had the effect of producing a more circularly symmetric output beam when the laser was used as an oscillator. However, in FIG. 8, it can be observed that when used as an amplifier this caused an angular displacement of the beam from the optical path. Not shown schematically are the other optical components that also added to the angular displacement.

Passing through the optical train of the laser has the additional effect of adding optical power to the system. This causes the shortened and amplified laser pulses to exhibit an intermediate focal point. While the original output from the laser was fairly well collimated and required a small compensating negative lens, the shortened pulse exhibited air breakdown in the region.

Two separate and distinct paths are taken by the oscillator output. The 1^{st} path is directly from the oscillator output and its return. When the amplified beam exits the laser cavity for the second time, it follows a 2^{nd} path to and from the PC SBS cell. After passing through the laser (again acting as an amplifier) it follows the 1^{st} path, and so on. So the odd laser outputs follow the 1^{st} path and the even outputs follow the 2^{nd} path. This was observed experimentally. It is likely that optically induced aberrations introduced in the 2^{nd} path, or even output, are canceled out along the 1^{st} path, even outputs.

### Gain Considerations

Starting with a 20 nsec pulse with an energy of 85 mJ per pulse, a portion of that pulse was reflected (about 20%) at a PC efficiency of about 30%. This represents a total efficiency of approximately 6% or 5.1 mJ. The output after shortening and amplification is a 2 nsec pulse with an energy of 150 mJ, representing a large signal gain of approximately 30. Assuming that each succeeding pulse has minimal additional shortening, and that they are also reflected at a PC efficiency of 30%, then the large signal gain for each pulse must be at least 33%. In testing of the present invention a pulse train of up to seven pulses, above the original laser output was observed.

The present invention represents a useful tool in producing shortened laser pulses from not only Nd:YAG, but from a variety of pulse lasers operating at wavelengths at which SBS has been observed. This would be particularly useful for tunable lasers such as Ti-Sapphire. It appears that the characteristics of the first shortened pulse can be selected by judicious choice of nonlinear medium and focal length of the lens focusing the light into the SBS cell. While the basic compression scheme is rather inefficient (as low as 6%) using untapped energy stored in the same laser rod used to produce the pulse makes the overall process very efficient. The present invention is particularly robust because it is based on SBS phase conjugation and was found to be particularly insensitive to vibration, misalignment, and optical quality of the elements.

As those skilled in the art will appreciate, what is new with respect to the prior art is the beam expander, the passive or active extraction method and the matched filter. The beam expander reduces the optical damage sustained previously by reducing the high power density for sub-nanosecond systems operating at high-energy outputs as demonstrated previously. The passive extraction system is not as yet clearly defined, but is either based three passes through the system using polarization rotation, or on a nonlinear element at the actual extraction point using a material that becomes highly reflective at the expected intensity. The matched filter is expected to “clean up” the beam sufficiently for propagation as a laser illumination source where range resolution is determined by pulse length and range is determined by energy output. It is expected that the system will be readily converted to “eye safe” laser wavelength operation by switching the lasing media to one that lases at or about 1.54 μm (which generally is expected to have a lower gain than Nd:YAG system) and by compensating for the lower gain by using a higher gain SBS fluid.

What is claimed is:

1. A high power laser source comprising:
A laser having an oscillator that produces an output laser pulse;
a matched filter through which the output pulse passes and is filter and focused;
an SBS cell wherein the output pulse is focused into the SBS cell such that the SBS cell produces a return pulse that is both phase conjugated and sliced;
wherein the return pulse returns back through the matched filter and enters the oscillator such that the oscillator acts as a two pass amplifier.

2. The high power laser source of claim 1 wherein the output pulse which has been filtered and focused from the matched filter enters the SBS cell such that an acoustic grating is formed in the SBS cell from the output pulse thereby acting as a mirror to reflect the output pulse from the SBS cell.

3. The high power laser source of claim 1 wherein the diode pumped laser includes a beam expander which reduces the optical damage sustained by the return pulse.

4. The high power laser source of claim 1 further comprising a passive extraction means wherein the passive extraction means extracts the output pulse of the laser after three passes through the system using polarization rotation.

5. The high power laser source of claim 1 further comprising a passive extraction means wherein the passive extraction means comprises a nonlinear element at the actual extraction point using a material that becomes highly reflective at a predetermined intensity.

6. The high power laser source of claim 1 wherein matched filter filters the beam sufficiently for propagation as a laser illumination source where range resolution is determined by pulse length and range is determined by energy output.

7. The high power laser source of claim 1 wherein the high power laser source may be operated in an eye safe laser wavelength operation by switching the lasing media to one that lases at or about 1.54 μm and by compensating for a lower gain by using a higher gain SBS fluid.

8. The high power laser source of claim 1 further comprising an optical element which provides angular discrimination to the laser pulse, the optical element being disposed after the matched filter.

9. The high power laser source of claim 8 wherein the optical element is a lenslet array.

10. The high power laser source of claim 8 wherein the optical element is a binary optic lenslet array.

11. A method of producing a high power laser output comprising the steps of:
Providing a diode pumped laser having an oscillator that produces an output laser pulse;
Focusing and filtering the output pulse through a matched filter; and
Focusing the the focused and filtered output pulse into an SBS cell such that the SBS cell produces a return pulse that is both phase conjugated and sliced;
wherein the return pulse returns back through the matched filter and enters the oscillator such that the oscillator acts as a two pass amplifier.

12. The method of claim 11 wherein the output pulse which has been filtered and focused from the matched filter enters the SBS cell such that an acoustic grating is formed in the SBS cell from the output pulse thereby acting as a mirror to reflect the output pulse from the SBS cell.

13. The method of claim 11 wherein the diode pumped laser further comprises a beam expander which reduces the optical damage sustained by the return pulse.

14. The method of claim 11 further providing for a passive extraction means wherein the passive extraction means extracts the output pulse of the laser after three passes through the system using polarization rotation.

15. The method of claim 11 further comprising the step of passively extracting the output pulse by providing for a nonlinear element at the actual extraction point using a material that becomes highly reflective at a predetermined intensity.

16. The method of claim 11 wherein matched filter filters the beam sufficiently for propagation as a laser illumination source where range resolution is determined by pulse length and range is determined by energy output.

17. The method of claim 11 wherein the laser may be operated at an eye safe wavelength by switching a lasing media to one that lases at or about 1.54 μm and by compensating for a lower gain by using a higher gain SBS fluid.

18. The method of claim 11 further comprising the step of providing an optical element, which provides angular discrimination to the laser pulse, the optical element being disposed after the matched filter.

19. The high power laser source of claim 18 wherein the optical element is a lenslet array.

20. The high power laser source of claim 18 wherein the optical element is a binary optic lenslet array.
